(19) United States
(12) Patent Application Publication
(10) Pub. No.: US 2025/0053470 A1
(43) Pub. Date: Feb. 13, 2025

(54) EXTENDED ERROR MANAGEMENT WITH CONFIGURABLE HEADER LOGS

(71) Applicant: Intel Corporation, Santa Clara, CA (US)

(72) Inventors: Diego Garcia Rodriguez, Guadalajara (MX); Omar Avelar Suarez, Zapopan (MX); Claudia Barajas Rivera, Zapopan (MX); Gaurav Porwal, Portland, OR (US); Luis Gonzalez Perez, Zapopan (MX)

(73) Assignee: Intel Corporation, Santa Clara, CA (US)

(21) Appl. No.: 18/231,695

(22) Filed: Aug. 8, 2023

(51) Int. Cl. G06F 11/07; G06F 13/40

(52) U.S. Cl. CPC G06F 11/0745; G06F 13/4022; G06F 2213/0026

(57) ABSTRACT

An example of an apparatus may include a processor to process request transactions and completion transactions for one or more respective communication protocols, memory coupled to the processor to store error-related transaction information, and circuitry coupled to the memory to save the error-related transaction information in the memory for both the request transactions and the completion transactions for the one or more respective communication protocols. Other examples are disclosed and claimed.

### BACKGROUND

A Peripheral Component Interconnect Express (PCIe) compliant device implements a basic level of error management and can optionally implement advanced error management. The PCIe Advanced Error Reporting (AER) capability is an optional extended capability that may be implemented by PCIe device functions supporting advanced error control and reporting. The Compute Express Link (CXL) protocol includes reliability, availability, and serviceability (RAS) features for error management.

There is an ongoing need for improved computational devices to enable ever increasing demand for modeling complex systems, providing reduced computation times, and other considerations. In particular, there is an ongoing desire to improve error management circuits that are included in or otherwise support operation of integrated circuits. It is with respect to these and other considerations that the present improvements have been needed. Such improvements may become critical as the desire to improve computational efficiency becomes even more widespread.

### BRIEF DESCRIPTION OF DRAWINGS

Various examples in accordance with the present disclosure will be described with reference to the drawings, in which:

FIG. 1 is a block diagram of an example of an apparatus in one implementation.

FIG. 2 is a block diagram of another example of an apparatus in one implementation.

FIG. 3 is a block diagram of an example of an electronic device in one implementation.

FIG. 4 is an illustrative diagram of an example of a set of registers in one implementation.

FIGS. 5A to 5F are illustrative diagram of examples of registers in some implementations.

FIG. 6 is a block diagram of an example of error management flows in one implementation.

FIG. 7 is a block diagram of another example of error management flows in one implementation.

FIG. 8 illustrates an example of another computing system.

FIG. 9 illustrates a block diagram of an example processor and/or System on a Chip (SOC) that may have one or more cores and an integrated memory controller.

FIG. 10A is a block diagram illustrating both an example in-order pipeline and an example register renaming, out-of-order issue/execution pipeline according to examples.

FIG. 10B is a block diagram illustrating both an example in-order architecture core and an example register renaming, out-of-order issue/execution architecture core to be included in a processor according to examples.

FIG. 11 illustrates examples of execution unit(s) circuitry.

FIG. 12 is a block diagram of a register architecture according to some examples.

FIG. 13 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for extended error management with configurable header logs. According to some examples, the technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide extended error management with configurable header logs.

In the following description, numerous details are discussed to provide a more thorough explanation of the examples of the present disclosure. It will be apparent to one skilled in the art, however, that examples of the present disclosure may be practiced without these specific details. In other instances, well-known structures and devices are shown in block diagram form, rather than in detail, in order to avoid obscuring examples of the present disclosure.

Note that in the corresponding drawings of the examples, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the examples of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Computer devices may employ a wide variety of error management mechanisms via hardware (HW), software (SW), firmware (FW), and combinations thereof. For example, a Peripheral Component Interconnect Express (PCIe) device may include Advanced Error Reporting (AER) technology that provides a four (4) double word (DW) Transaction Layer Packet (TLP) associated with an uncorrectable error. In another example, a Compute Express Link (CXL) device may include a reliability, availability, and serviceability (RAS) capability structure that provides sixteen (16) DW flit information that is associated with uncorrectable errors. SW and/or users may utilize header log information from the provided TLPs or CXL RAS structure(s) to debug and/or handle various failure situations. A problem is that limitations in conventional header log implementations make various scenarios more difficult to debug and/or handle.

In a PCIe protocol, for example, memory and input/output (IO) request headers have the full destination address information. Configuration transactions include the bus/device/function (BDF) where an error happens in a completion transaction. A problem, however, is that the completion headers do not have full information of the address from where data is coming.

In a CXL protocol, for example, header log information is captured because poison errors for uncorrectable recoverable scenarios are logged in the C×L correctable error register. The error data may be collected from the CXL Event Record that shows limited and generic data from the transaction that generated the error.

In PCIe and CXL protocols, for example, correctable errors may conventionally be handled by HW because no SW intervention is needed. A problem is that no header log information is collected, and the error register may only report error type data. As a result, the SW and/or user may not have sufficient information to handle and debug correctable errors. More data may be collected by using a protocol logic analyzer, but a problem is that such equipment is expensive and cumbersome when debugging in at scale environments.

Some examples described herein overcome one or more of the foregoing problems. Some examples provide technology for extended error management with configurable header logs. In some examples, a set of memory mapped log registers may be utilized to record request and completion transactions for PCIe and CXL protocols when both correctable and uncorrectable errors are reported in a PCIe AER protocol or in a CXL RAS capability structure. Some example may provide a single error logging solution for both PCIe and CXL protocols. Some examples may further provide an informative miscellaneous status register for each of any number of error severity levels. For example, the status register may reflect important data from the error captured in the header log. Advantageously, the status register can be readily used by SW to take corrective or preventive actions and/or can readily be checked by the user or telemetry to debug any failure.

In contrast to some error management technology, some examples provide technology for transaction logging for both request and completion transactions. The errors that happen in completions may be difficult to trace with conventional technology. Some examples may provide the full transaction headers to help identify an error source, advantageously facilitating the debug and allowing SW make usage of the extra data and to handle the error in a more efficient way.

In contrast to some error management technology, some examples provide technology for header logging for correctable errors and miscellaneous error information (e.g., in addition to header logging for uncorrectable errors). Advantageously, the extra severity information from correctable errors allows SW to take preventive and corrective actions for correctable errors. For example, providing the header log information for a recoverable poison error in CXL that is logged as correctable error allows SW to implement actions such as preventing access to the poisoned location in the operating system (OS) and to have field replaceable unit (FRU) isolation data indicated by the miscellaneous error information register such that the failing unit may be flagged for replacement.

Some examples may provide technology for enhancing AER and/or CXL RAS capabilities using vendor-defined header logs. To expand the data collected in CXL and PCIe errors with a new enhanced set of vendor-defined header log registers that includes miscellaneous error information and header logs for completions and request with correctable and uncorrectable severities. In some examples, additional vendor-defined header logs may be integrated in PCIe/CXL capabilities/structures such that the additional vendor-defined header logs coexist with and/or complement the errors reported in AER and CXL RAS. In some examples, additional vendor-defined header logs may be implemented with an extra set of memory-mapped IO (MMIO) registers that may be added directly into the circuit block of interest to improve the error reporting capability. In some examples, SW and/or a user may set configurable header log options to include only selected information/reporting.

Advantageously, some examples may allow SW to analyze and debug failures without the need of additional equipment in the platforms, making the validation and debugging efforts more cost effective, especially at scale environments. In some examples, another advantage is that header log information collected from both request and completion transactions may be easier to correlate and find an error source. In some examples, another advantage is that data is collected from more or all types of failures and error header log information may be available in more or all of the severities (e.g., correctable error, uncorrectable error, recoverable error, unrecoverable error, etc.). In some examples, another advantage is that extra error miscellaneous information may be available (e.g., via an error status register) that can be used by SW and/or users to implement mechanisms to predict or prevent failures and/or to take corrective actions.

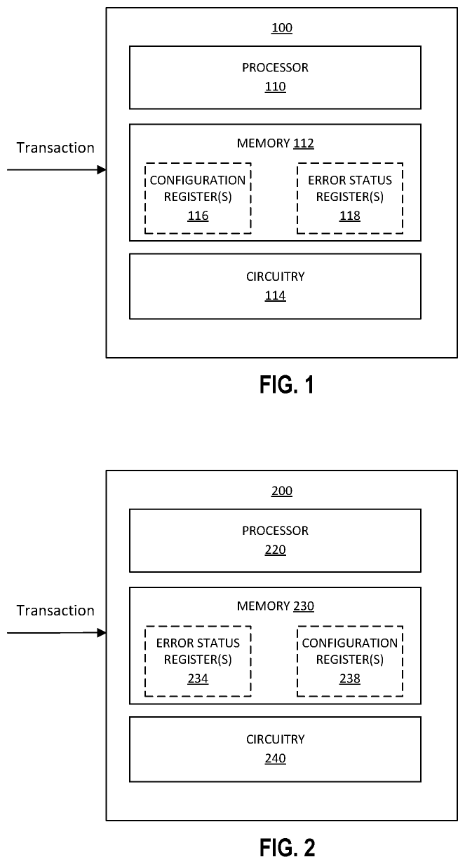

With reference to FIG. 1, an example of an apparatus 100 (e.g., an integrated circuit (IC), an electronic system, a SOC, etc.) may include a processor 110 to process request transactions and completion transactions for one or more respective communication protocols, memory 112 coupled to the processor 110 to store error-related transaction information, and circuitry 114 (e.g., HW, SW, FW, and combinations thereof) coupled to the memory 112 to save the error-related transaction information in the memory 112 for both the request transactions and the completion transactions for the one or more respective communication protocols. For example, the memory 112 may comprise a set of memory-mapped registers. In some examples, the circuitry 114 may be configured to save the error-related transaction information in the memory 112 for both the request transactions and the completion transactions for two or more respective communication protocols. For example, the two or more respective communication protocols may include at least a PCIe protocol and a CXL protocol.

In some examples, the error-related transaction information at least includes header log information associated with a completion transaction. In some examples, the error-related transaction information at least includes header log information associated with a correctable error. In some examples, the memory 112 may optionally comprise one or more configuration register(s) 116, and the circuitry 114 may be configured to save the error-related transaction information in the memory 112 based on one or more respective values from the one or more configuration registers 116.

In some examples, the circuitry 114 may be configured to save the error-related transaction information in the memory associated with two or more error severity levels. For example, the apparatus 100 may optionally include two or more registers 118 to store respective status information associated with two or more error severity levels. For example, the two or more error severity levels may include at least a correctable error severity level and an uncorrectable error severity level.

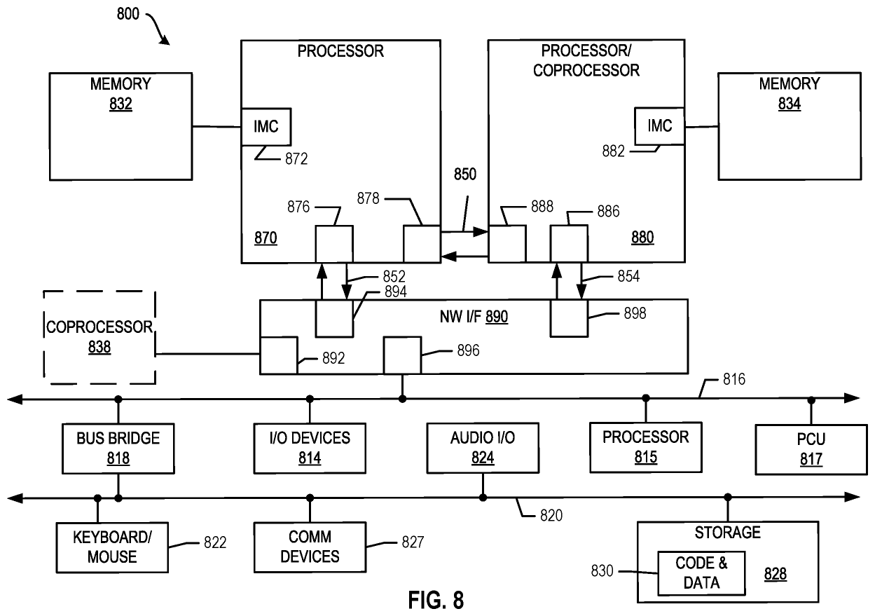

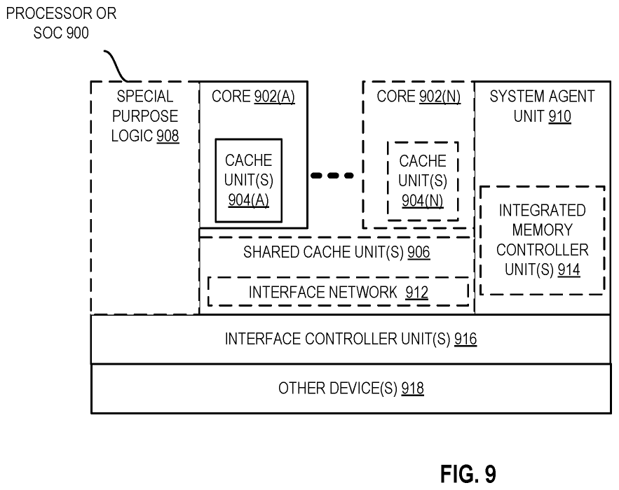

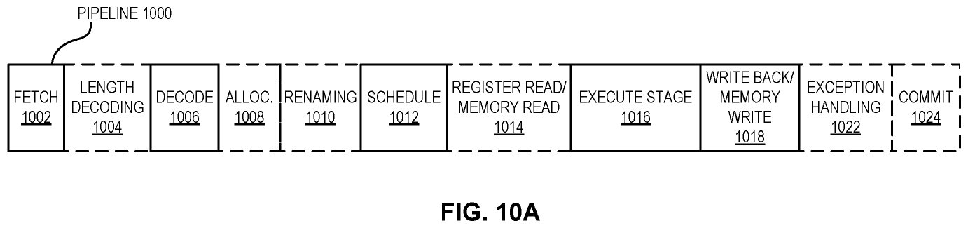

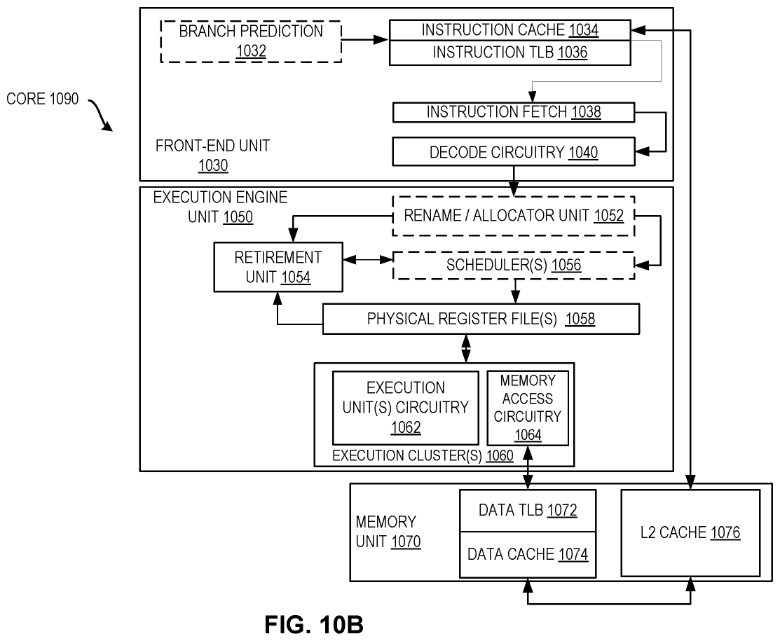

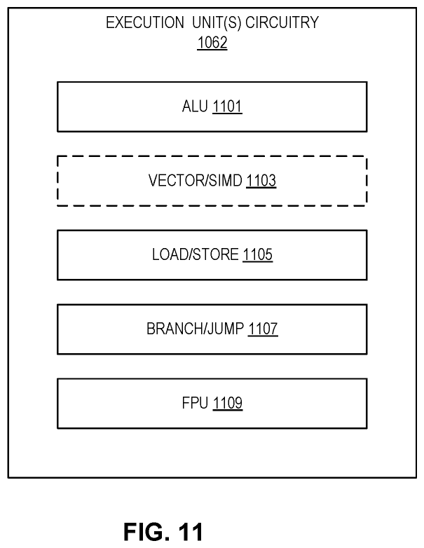

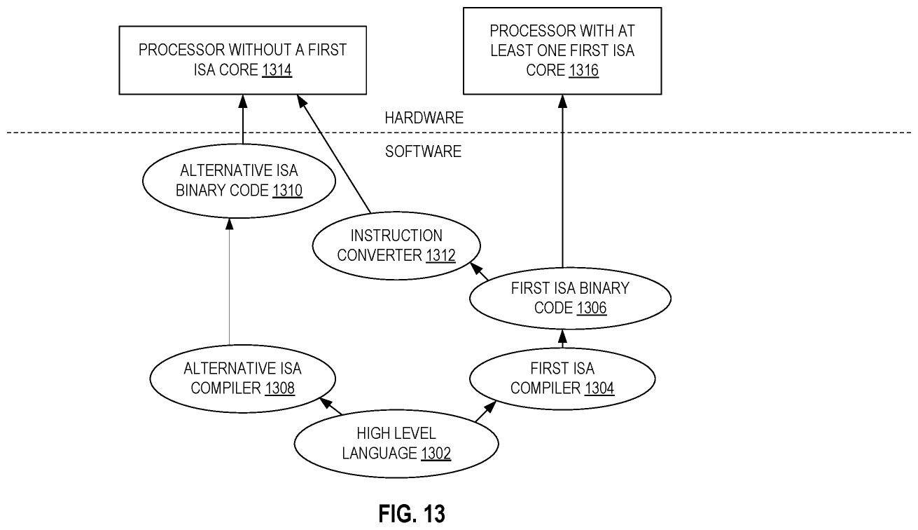

For example, the apparatus 100 may be integrated/incorporated with/in any of the processors described herein. In particular, any/all of the processor 110, the memory 112, and/or the circuitry 114 may be integrated/incorporated with/in the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13).

With reference to FIG. 2, an example of an apparatus 200 (e.g., an IC, an electronic system, a SOC, etc.) may include a processor 220 to process request transactions and completion transactions for one or more respective communication protocols, memory 230 coupled to the processor 220 to store error-related transaction information, and circuitry 240 (e.g., HW, SW, FW, and combinations thereof) coupled to the memory 230 to save the error-related transaction information in the memory 230 associated with two or more error severity levels for the one or more respective communication protocols. For example, the memory 230 may comprise a set of memory-mapped registers. In some examples, the apparatus 200 may optionally include two or more registers 234 to store respective status information associated with two or more error severity levels. For example, the two or more error severity levels may include at least a correctable error severity level and an uncorrectable error severity level.

In some examples, the error-related transaction information at least includes header log information associated with a completion transaction. In some examples, the error-related transaction information at least includes header log information associated with a correctable error. In some examples, the memory 230 may comprise one or more configuration registers 238, and the circuitry 240 may be configured to save the error-related transaction information in the memory 230 based on one or more respective values from the one or more configuration registers 238.

In some examples, the circuitry 240 may be configured to save the error-related transaction information in the memory 230 for both the request transactions and the completion transactions for the one or more respective communication protocols. In some examples, the circuitry 240 may be further configured to save the error-related transaction information in the memory 230 for both the request transactions and the completion transactions for two or more respective communication protocols. For example, the two or more respective communication protocols may include at least a PCIe protocol and a CXL protocol.

For example, the apparatus 200 may be integrated/incorporated with/in any of the processors described herein. In particular, any/all of the processor 220, the memory 230, and/or the circuitry 240 may be integrated/incorporated with/in the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13).

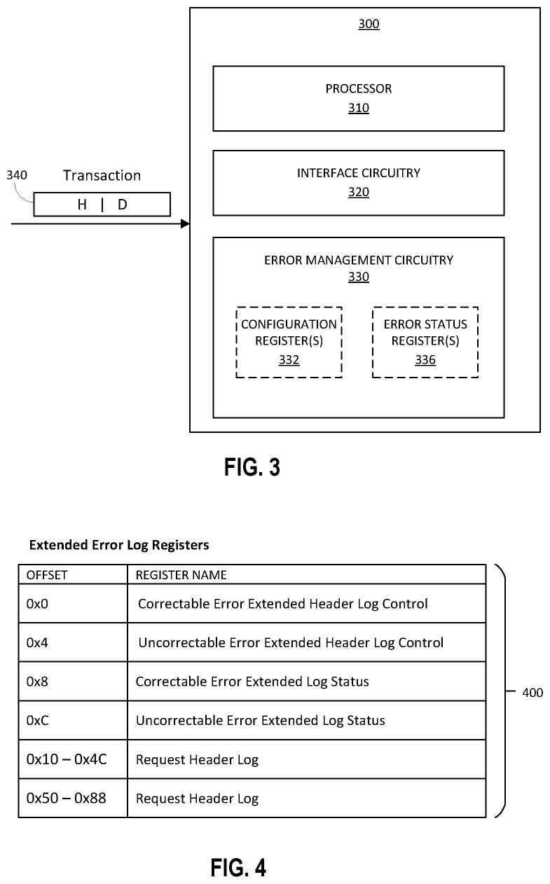

With reference to FIG. 3, an example of an electronic device 300 (e.g., an IC, a SOC, etc.) may include a processor 310, interface circuitry 320 (e.g., HW, SW, FW, and combinations thereof) coupled to the processor 310 to support one or more communication protocols, and error management circuitry 330 (e.g., HW, SW, FW, and combinations thereof) to collect header log information from both request transactions and completion transactions for the one or more communication protocols. For example, a transaction 340 for the communication protocols may include a header portion H and a data portion D. In some examples, the header log information at least includes information associated with a completion transaction. In some examples, the header log information at least includes information associated with a correctable error. In some examples, the error management circuitry 330 may comprise one or more configuration registers 332, and the error management circuitry 330 may be configured to collect the header log information based on one or more respective values from the one or more configuration registers 332.

In some examples, the error management circuitry 330 may be configured to collect header log information associated with two or more error severity levels. For example, the error management circuitry 330 may be further configured to provide status information respectively associated with the two or more error severity levels (e.g., via error status register(s) 336). For example, the two or more error severity levels may include at least a correctable error severity level and an uncorrectable error severity level.

In some examples, the error management circuitry 330 may be configured to collect header log information for both the request transactions and the completion transactions for two or more respective communication protocols. For example, the two or more respective communication protocols include at least a PCIe protocol and a CXL protocol. In some examples, the error management circuitry 330 may comprise a set of memory-mapped registers to store the collected header log information.

For example, the device 300 may be integrated/incorporated with/in any of the processors described herein. In particular, any/all of the processor 310, interface circuitry 320, and/or error management circuitry 330 may be integrated/incorporated with/in the processor 800, the processor 870, the processor 815, the coprocessor 838, and/or the processor/coprocessor 880 (FIG. 8), the processor 900 (FIG. 9), the core 1090 (FIG. 10B), the execution units 1062 (FIGS. 10B and 11), and the processor 1316 (FIG. 13).

In some implementations, one or more features or aspects of the examples described herein may be included in extended capability structures and/or in a device MMIO space. For example, some implementations may include a register for correctable error extended log control, a register for correctable error extended log status, a register for uncorrectable error extended log control, a register for uncorrectable error extended log status, a register for logging request header log data, and a register for logging completion header log data. For PCIe/CXL device implementations, the capability register(s) may be indicated by utilizing suitable capabilities pointer technology. For other implementations, suitable MMIO registers and locations may be otherwise specified or identified for use by the SW and/or user. Given the benefit of the present specification and drawings, those skilled in the art will appreciate that a wide variety of technologies may be utilized to implement one or more aspects of the various examples described herein. Accordingly, the foregoing and following examples should be considered as only illustrative and not limiting.

FIG. 4 shows a table of extended error log registers 400, in accordance with some examples. The set of registers 400 may comprise MMIO registers that may be part of PCIe/CXL extended capabilities or may be added directly as an extended MMIO set of registers for any circuit block or device that may benefit from an enhanced error reporting capability. The set of registers 400 may be utilized to control the logging and to read the collected information from the errors. The indicated offsets and sizes are nominal. In the illustrated example, the registers 400 include a DW Correctable Error Extended Header Log Control register, a DW Uncorrectable Error Extended Header Log Control register, a DW Correctable Error Extended Log Status register, a DW Uncorrectable Error Extended Log Status register, a 16 DW Request Header Log register, and a 16 DW Completion Header Log register.

The registers 400 may be utilized together with suitable HW/FW/SW logic to provide an enhanced vendor-defined header log capability that allows collection of header log information from all the errors reported in a PCIe AER, a CXL RAS capability, or other error management mechanism. The status register may be utilized to log miscellaneous errors to complement the information captured in the header log. Examples of further details for the registers 400 are indicated below.

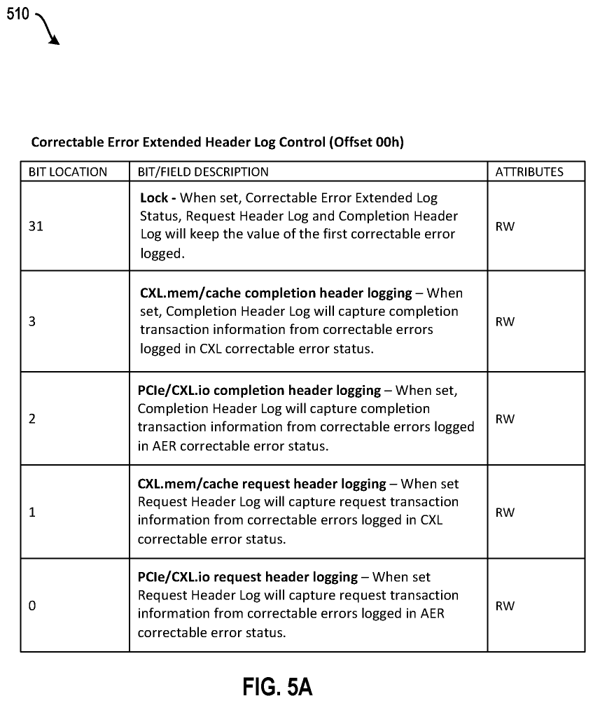

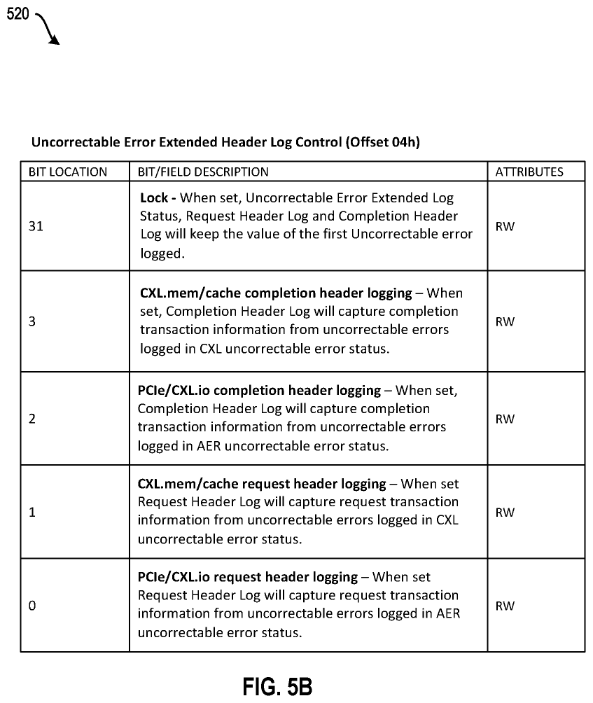

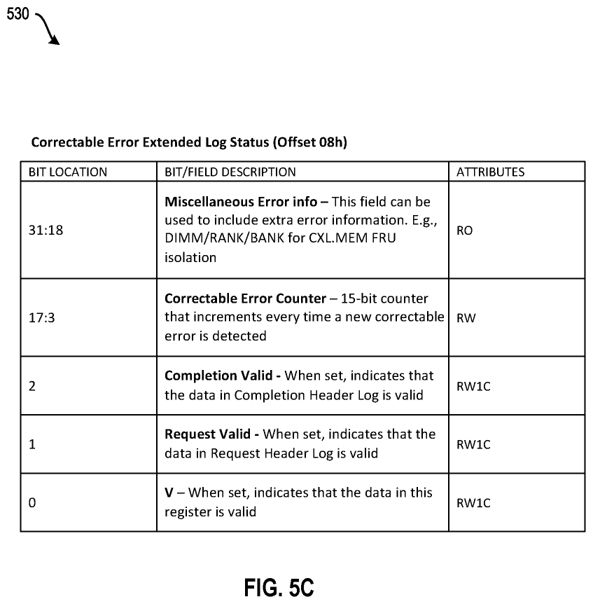

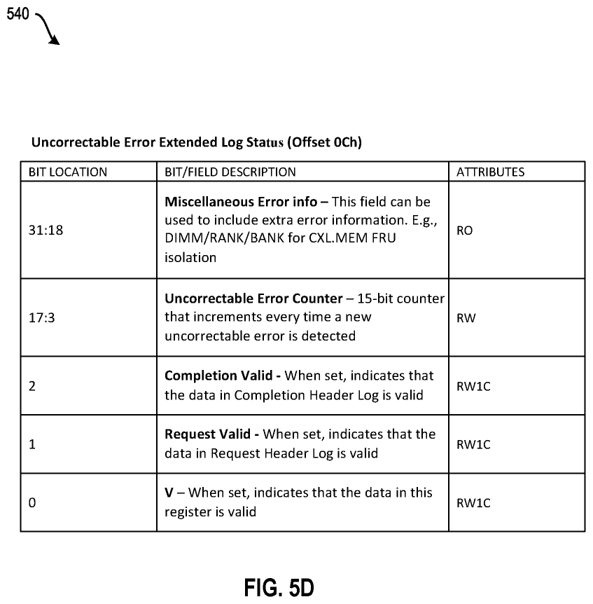

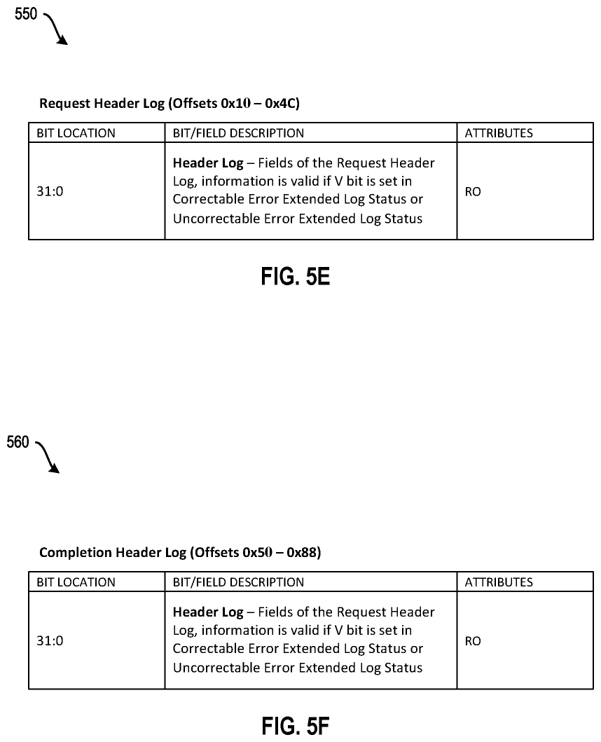

FIGS. 5A to 5F show illustrative tables with example details of bit locations, bit/field descriptions, and attributes for various registers. The example bit locations, descriptions, and attributes should be considered as illustrative only. The various attributes correspond to read and write access (RW), read only (RO), and read write 1 to clear (RW1C).

With reference to FIG. 5A, an example Correctable Error Extended Header Log Control register 510 includes a Lock field at bit location 31. When the Lock field is set, the Correctable Error Extended Log Status register, the Request Header Log register, and the Completion Header Log register will keep the value of the first correctable error logged. Bit location 3 of the register 510 corresponds to a CXL.mem/cache completion header logging field. When the CXL.mem/cache completion header logging field is set, the Completion Header Log register will capture completion transaction information from correctable errors logged in the C×L correctable error status. Bit location 2 of the register 510 corresponds to a PCIe/CXL.io completion header logging field. When the PCIe/CXL.io completion header logging field is set, the Completion Header Log register will capture completion transaction information from correctable errors logged in AER correctable error status. Bit location 1 of the register 510 corresponds to a CXL.mem/cache request header logging field. When the CXL.mem/cache request header logging field is set, the Request Header Log register will capture request transaction information from correctable errors logged in C×L correctable error status. Bit location 0 of the register 510 corresponds to a PCIe/CXL.io request header logging field. When the PCIe/CXL.io request header logging field is set, the Request Header Log register will capture request transaction information from correctable errors logged in AER correctable error status.

With reference to FIG. 5B, an example Uncorrectable Error Extended Header Log Control register 520 includes a Lock field at bit location 31. When the Lock field is set, the Uncorrectable Error Extended Log Status register, the Request Header Log register, and the Completion Header Log register will keep the value of the first Uncorrectable error logged. Bit location 3 of the register 520 corresponds to a CXL.mem/cache completion header logging field. When the CXL.mem/cache completion header logging field is set, the Completion Header Log register will capture completion transaction information from uncorrectable errors logged in C×L uncorrectable error status. Bit location 2 of the register 520 corresponds to a PCIe/CXL.io completion header logging field. When the PCIe/CXL.io completion header logging field is set, the Completion Header Log register will capture completion transaction information from uncorrectable errors logged in AER uncorrectable error status. Bit location 1 of the register 520 corresponds to a CXL.mem/cache request header logging field. When the CXL.mem/cache request header logging field is set, the Request Header Log register will capture request transaction information from uncorrectable errors logged in C×L uncorrectable error status. Bit location 0 of the register 520 corresponds to a PCIe/CXL.io request header logging field. When the PCIe/CXL.io request header logging field is set, the Request Header Log register will capture request transaction information from uncorrectable errors logged in AER uncorrectable error status.

With reference to FIG. 5C, an example Correctable Error Extended Log Status register 530 includes a Miscellaneous Error info field at bit location 31:18. The Miscellaneous Error info field may be utilized to include extra error information (e.g., dual-inline memory module (DIMM)/RANK/BANK for CXL.MEM FRU isolation). Bit location 17:3 of the register 530 corresponds to a Correctable Error Counter field that may be utilized as a fifteen (15)-bit counter that increments every time a new correctable error is detected. Bit location 2 of the register 530 corresponds to a Completion Valid field. When the Completion Valid field is set, the data in the Completion Header Log register is indicated as valid. Bit location 1 of the register 530 corresponds to a Request Valid field. When the Request Valid field is set, the data in the Request Header Log register is indicated as valid. Bit location 0 of the register 530 corresponds to a V field. When the V field is set, the data in the register 530 is indicated as valid.

With reference to FIG. 5D, an example Uncorrectable Error Extended Log Status register 540 includes a Miscellaneous Error info field at bit location 31:18. The Miscellaneous Error info field may be utilized to include extra error information (e.g., dual-inline memory module (DIMM)/RANK/BANK for CXL.MEM FRU isolation). Bit location 17:3 of the register 540 corresponds to an Uncorrectable Error Counter field that may be utilized as a fifteen (15)-bit counter that increments every time a new uncorrectable error is detected. Bit location 2 of the register 540 corresponds to a Completion Valid field. When the Completion Valid field is set, the data in the Completion Header Log register is indicated as valid. Bit location 1 of the register 540 corresponds to a Request Valid field. When the Request Valid field is set, the data in the Request Header Log register is indicated as valid. Bit location 0 of the register 540 corresponds to a V field. When the V field is set, the data in the register 540 is indicated as valid.

With reference to FIG. 5E, an example Request Header Log register 550 includes a Header Log field at bit location 31:0. The Header Log field corresponds to information from the request transaction headers. The information in the register 550 is considered valid if the Request Valid field (e.g., bit location 1) is set in the Correctable Error Extended Log Status register or the Uncorrectable Error Extended Log Status register.

With reference to FIG. 5F, an example Completion Header Log register 560 includes a Header Log field at bit location 31:0. The Header Log field corresponds to information from the completion transaction headers. The information in the register 560 is considered valid if the Completion Valid field (e.g., bit location 2) is set in the Correctable Error Extended Log Status register or the Uncorrectable Error Extended Log Status register.

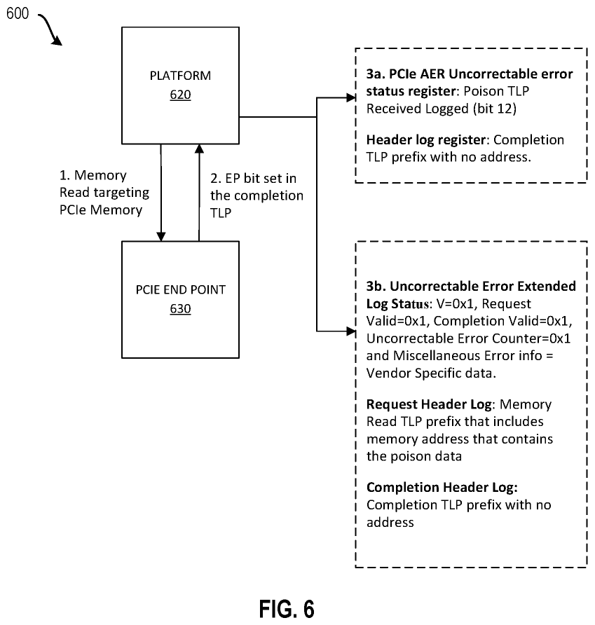

FIG. 6 shows an example process flow for a system 600 that includes a platform 620 communicatively coupled with a PCIe end point device 630. The platform 620 is configurable and may selectively enable one or more features or aspects of the various examples described herein (e.g., nominally referred to in this example as vendor-defined header log capability). At 1, a read from the platform 620 targets the PCIe end point device 630. At 2, the completion with data returns but the completion TLP has the poison bit set to indicate that the data returned is corrupted. If the vendor-defined header log capability is not enabled, at 3a the receipt of the poison TLP is logged in the PCIe AER uncorrectable error status register and the header log register collects the completion TLP prefix with no address.

If the vendor-defined header log capability is enabled, at 3b the Uncorrectable Error Extended Log Status register is updated (e.g., such that the V field is set, the Request Valid field is set, the Completion Valid field is set, the Uncorrectable Error Counter field is set to one (e.g., or incremented), and the Miscellaneous Error Info field is set with vendor specific data (e.g., request address information that may be helpful for handling poison data issues)), the Request Header Log register is updated (e.g., to include the memory read TLP prefix that includes the memory address that contains poison data), and the Completion Header Log register is updated (e.g., to include the completion TLP prefix with no address). Advantageously, information logged by AER combined with additional information logged by vendor-defined header log capability registers may be utilized by SW and/or users to improve the poison handling in the PCIe domain. Another advantage is that SW and/or users may readily determine the memory location where the poison error originated.

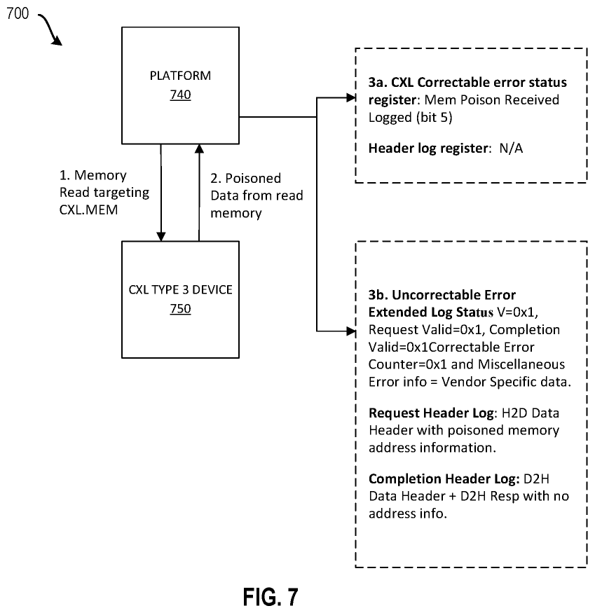

FIG. 7 shows an example process flow for a system 700 that includes a platform 740 communicatively coupled with a PCIe end point device 750. The platform 740 is configurable and may selectively enable one or more features or aspects of the various examples described herein (e.g., nominally referred to in this example as vendor-defined header log capability). At 1, a read from the platform 740 targets a CXL Type 3 device. At 2, the read data returns but the data has the poison bit set to indicate that the data returned is corrupted. If the vendor-defined header log capability is not enabled, at 3a the receipt of the poison data is logged in the C×L correctable error status register and nothing is collected by the header log register.

If the vendor-defined header log capability is enabled, at 3b the Uncorrectable Error Extended Log Status register is updated (e.g., such that the V field is set, the Request Valid field is set, the Completion Valid field is set, the Correctable Error Counter field is set to one (e.g., or incremented), and the Miscellaneous Error Info field is set with vendor specific data (e.g., DIMM/RANK/BANK where the failure happened for FRU isolation)), the Request Header Log register is updated (e.g., to include the host-to-device (H2D) header information with the poisoned memory address information), and the Completion Header Log register is updated (e.g., to include the device-to-host (D2H) data header and the D2H response with no address information). Advantageously, information logged by CXL RAS capability structures combined with additional information logged by vendor-defined header log capability registers may be utilized by SW and/or users to take corrective or preventative actions in parallel with a poison recovery flow (e.g., some examples may also provide information for FRU isolation).

Those skilled in the art will appreciate that a wide variety of devices may benefit from the foregoing examples. The following exemplary core architectures, processors, and computer architectures are non-limiting examples of devices that may beneficially incorporate examples of the technology described herein.

### Example Computer Architectures.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable. Some examples may be particularly beneficial for parallel computing applications, a GPU (e.g., as part of a discrete graphics card), a SIMD processor, an AI processor, ML applications, and neural network processing applications.

FIG. 8 illustrates an example computing system. Multiprocessor system 800 is an interfaced system and includes a plurality of processors or cores including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is a system on a chip (SOC).

Processors 870 and 880 are shown including integrated memory controller (IMC) circuitry 872 and 882, respectively. Processor 870 also includes interface circuits 876 and 878; similarly, second processor 880 includes interface circuits 886 and 888. Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SOC) that may be included on the same die as the described CPU (sometimes referred to as the application core(s) or application processor(s)), the above described coprocessor, and additional functionality. Example core architectures are described next, followed by descriptions of example processors and computer architectures.

FIG. 9 illustrates a block diagram of an example processor and/or SOC 900 that may have one or more cores and an integrated memory controller. The solid lined boxes illustrate a processor 900 with a single core 902(A), system agent unit circuitry 910, and a set of one or more interface controller unit(s) circuitry 916, while the optional addition of the dashed lined boxes illustrates an alternative processor 900 with multiple cores 902(A)-(N), a set of one or more integrated memory controller unit(s) circuitry 914 in the system agent unit circuitry 910, and special purpose logic 908, as well as a set of one or more interface controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902(A)-(N) being one or more general purpose cores (e.g., general purpose in-order cores, general purpose out-of-order cores, or a combination of the two); 2) a coprocessor with the cores 902(A)-(N) being a large number of special purpose cores intended primarily for graphics and/or scientific (throughput); and 3) a coprocessor with the cores 902(A)-(N) being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904(A)-(N) within the cores 902(A)-(N), a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples interface network circuitry 912 (e.g., a ring interconnect) interfaces the special purpose logic 908 (e.g., integrated graphics logic), the set of shared cache unit(s) circuitry 906, and the system agent unit circuitry 910, alternative examples use any number of well-known techniques for interfacing such units. In some examples, coherency is maintained between one or more of the shared cache unit(s) circuitry 906 and cores 902(A)-(N). In some examples, interface controller units circuitry 916 couple the cores 902 to one or more other devices 918 such as one or more I/O devices, storage, one or more communication devices (e.g., wireless networking, wired networking, etc.), etc.

In some examples, one or more of the cores 902(A)-(N) are capable of multi-threading. The system agent unit circuitry 910 includes those components coordinating and operating cores 902(A)-(N). The system agent unit circuitry 910 may include, for example, power control unit (PCU) circuitry and/or display unit circuitry (not shown). The PCU may be or may include logic and components needed for regulating the power state of the cores 902(A)-(N) and/or the special purpose logic 908 (e.g., integrated graphics logic). The display unit circuitry is for driving one or more externally connected displays.

The cores 902(A)-(N) may be homogenous in terms of instruction set architecture (ISA). Alternatively, the cores 902(A)-(N) may be heterogeneous in terms of ISA; that is, a subset of the cores 902(A)-(N) may be capable of executing an ISA, while other cores may be capable of executing only a subset of that ISA or another ISA.

### Example Core Architectures—In-Order and Out-of-Order Core Block Diagram.

FIG. 10A is a block diagram illustrating both an example in-order pipeline and an example register renaming, out-of-order issue/execution pipeline according to examples. FIG. 10B is a block diagram illustrating both an example in-order architecture core and an example register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to execution engine unit circuitry 1050, and both are coupled to memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front-end unit circuitry 1030 may include branch prediction circuitry 1032 coupled to instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, microcode entry points, microinstructions, other instructions, or other control signals, which are decoded from, or which otherwise reflect, or are derived from, the original instructions. The decode circuitry 1040 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front-end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, address generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to data cache circuitry 1074 coupled to level 2 (L2) cache circuitry 1076. In one example, the memory access circuitry 1064 may include load unit circuitry, store address unit circuitry, and store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Example Execution Unit(s) Circuitry.

FIG. 11 illustrates examples of execution unit(s) circuitry, such as execution unit(s) circuitry 1062 of FIG. 10B. As illustrated, execution unit(s) circuitry 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

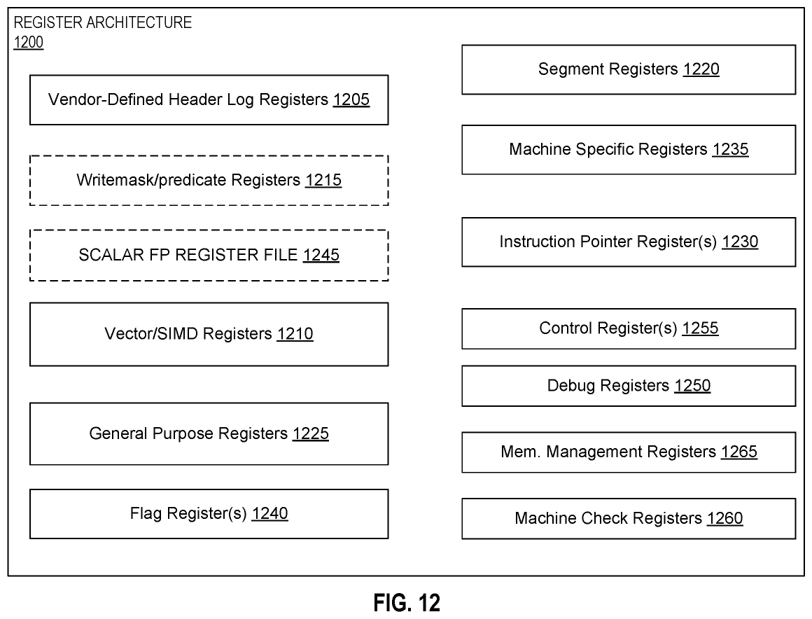

FIG. 12 is a block diagram of a register architecture 1200 according to some examples. The register architecture 1200 includes vendor-defined header log registers 1205, as described in connection with the various examples described herein. For example, the vendor-defined header log registers 1205 may include a Correctable Error Extended Header Log Control register, a Uncorrectable Error Extended Header Log Control register, a Correctable Error Extended Log Status register, a Uncorrectable Error Extended Log Status register, a Request Header Log register, and a Completion Header Log register.

As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register file 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1200 may, for example, be used in register file/memory, or physical register file(s) circuitry 10 58.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 13 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 13 shows a program in a high-level language 1302 may be compiled using a first ISA compiler 1304 to generate first ISA binary code 1306 that may be natively executed by a processor with at least one first ISA core 1316. The processor with at least one first ISA core 1316 represents any processor that can perform substantially the same functions as an Intel@processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1304 represents a compiler that is operable to generate first ISA binary code 1306 (e.g., object code) that can, with or without additional linkage processing, be executed on the processor with at least one first ISA core 1316. Similarly, FIG. 13 shows the program in the high-level language 1302 may be compiled using an alternative ISA compiler 1308 to generate alternative ISA binary code 1310 that may be natively executed by a processor without a first ISA core 1314. The instruction converter 1312 is used to convert the first ISA binary code 1306 into code that may be natively executed by the processor without a first ISA core 1314. This converted code is not necessarily to be the same as the alternative ISA binary code 1310; however, the converted code will accomplish the general operation and be made up of instructions from the alternative ISA. Thus, the instruction converter 1312 represents software, firmware, hardware, or a combination thereof that, through emulation, simulation or any other process, allows a processor or other electronic device that does not have a first ISA processor or core to execute the first ISA binary code 1306.

Techniques and architectures for extended error management with configurable header logs are described herein. In the above description, for purposes of explanation, numerous specific details are set forth in order to provide a thorough understanding of certain examples. It will be apparent, however, to one skilled in the art that certain examples can be practiced without these specific details. In other instances, structures and devices are shown in block diagram form in order to avoid obscuring the description

### Additional Notes and Examples

Example 1 includes an apparatus, comprising a processor to process request transactions and completion transactions for one or more respective communication protocols, memory coupled to the processor to store error-related transaction information, and circuitry coupled to the memory to save the error-related transaction information in the memory for both the request transactions and the completion transactions for the one or more respective communication protocols.

Example 2 includes the apparatus of Example 1, wherein the error-related transaction information at least includes header log information associated with a completion transaction.

Example 3 includes the apparatus of any of Examples 1 to 2, wherein the error-related transaction information at least includes header log information associated with a correctable error.

Example 4 includes the apparatus of any of Examples 1 to 3, wherein the memory comprises one or more configuration registers, and wherein the circuitry is further to save the error-related transaction information in the memory based on one or more respective values from the one or more configuration registers.

Example 5 includes the apparatus of any of Examples 1 to 4, wherein the circuitry is further to save the error-related transaction information in the memory associated with two or more error severity levels.

Example 6 includes the apparatus of Example 5, further comprising two or more registers to store respective status information associated with two or more error severity levels.

Example 7 includes the apparatus of any of Examples 5 to 6, wherein the two or more error severity levels include at least a correctable error severity level and an uncorrectable error severity level.

Example 8 includes the apparatus of any of Examples 1 to 7, wherein the circuitry is further to save the error-related transaction information in the memory for both the request transactions and the completion transactions for two or more respective communication protocols.

Example 9 includes the apparatus of Example 8, wherein the two or more respective communication protocols include at least a Peripheral Component Interconnect Express (PCIe) protocol and a Compute Express Link (CXL) protocol.

Example 10 includes the apparatus of any of Examples 1 to 9, wherein the memory comprises a set of memory-mapped registers.

Example 11 includes an apparatus, comprising a processor to process request transactions and completion transactions for one or more respective communication protocols, memory coupled to the processor to store error-related transaction information, and circuitry coupled to the memory to save the error-related transaction information in the memory associated with two or more error severity levels for the one or more respective communication protocols.

Example 12 includes the apparatus of Example 11, further comprising two or more registers to store respective status information associated with two or more error severity levels.

Example 13 includes the apparatus of any of Examples 11 to 12, wherein the two or more error severity levels include at least a correctable error severity level and an uncorrectable error severity level.

Example 14 includes the apparatus of any of Examples 11 to 13, wherein the error-related transaction information at least includes header log information associated with a completion transaction.

Example 15 includes the apparatus of any of Examples 11 to 14, wherein the error-related transaction information at least includes header log information associated with a correctable error.

Example 16 includes the apparatus of any of Examples 11 to 15, wherein the memory comprises one or more configuration registers, and wherein the circuitry is further to save the error-related transaction information in the memory based on one or more respective values from the one or more configuration registers.

Example 17 includes the apparatus of any of Examples 11 to 16, wherein the circuitry is further to save the error-related transaction information in the memory for both the request transactions and the completion transactions for the one or more respective communication protocols.

Example 18 includes the apparatus of Example 17, wherein the circuitry is further to save the error-related transaction information in the memory for both the request transactions and the completion transactions for two or more respective communication protocols.

Example 19 includes the apparatus of Example 18, wherein the two or more respective communication protocols include at least a Peripheral Component Interconnect Express (PCIe) protocol and a Compute Express Link (CXL) protocol.

Example 20 includes the apparatus of any of Examples 11 to 19, wherein the memory comprises a set of memory-mapped registers.

Example 21 includes an electronic device, comprising a processor, interface circuitry coupled to the processor to support one or more communication protocols, and error management circuitry to collect header log information from both request transactions and completion transactions for the one or more communication protocols.

Example 22 includes the electronic device of Example 21, wherein the header log information at least includes information associated with a completion transaction.

Example 23 includes the electronic device of any of Examples 21 to 22, wherein the header log information at least includes information associated with a correctable error.

Example 24 includes the electronic device of any of Examples 21 to 23, wherein the error management circuitry comprises one or more configuration registers, and wherein the error management circuitry is further to collect the header log information based on one or more respective values from the one or more configuration registers.

Example 25 includes the electronic device of any of Examples 21 to 24, wherein the error management circuitry is further to collect header log information associated with two or more error severity levels.

Example 26 includes the electronic device of Example 25, wherein the error management circuitry is further to provide status information respectively associated with the two or more error severity levels.

Example 27 includes the electronic device of any of Examples 25 to 26, wherein the two or more error severity levels include at least a correctable error severity level and an uncorrectable error severity level.

Example 28 includes the electronic device of any of Examples 21 to 27, wherein the error management circuitry is further to collect header log information for both the request transactions and the completion transactions for two or more respective communication protocols.

Example 29 includes the electronic device of Example 28, wherein the two or more respective communication protocols include at least a Peripheral Component Interconnect Express (PCIe) protocol and a Compute Express Link (CXL) protocol.

Example 30 includes the electronic device of any of Examples 21 to 29, wherein the error management circuitry comprises a set of memory-mapped registers to store the collected header log information.

Example 31 includes a method, comprising processing request transactions and completion transactions for one or more respective communication protocols, and logging error-related transaction information for both the request transactions and the completion transactions for the one or more respective communication protocols.

Example 32 includes the method of Example 31, wherein the error-related transaction information at least includes header log information associated with a completion transaction.

Example 33 includes the method of any of Examples 31 to 32, wherein the error-related transaction information at least includes header log information associated with a correctable error.

Example 34 includes the method of any of Examples 31 to 33, further comprising logging the error-related transaction information based on one or more respective values from one or more configuration registers.

Example 35 includes the method of any of Examples 31 to 34, further comprising logging error-related transaction information in the memory associated with two or more error severity levels.

Example 36 includes the method of Example 35, further comprising storing respective status information associated with two or more error severity levels.

Example 37 includes the method of any of Examples 35 to 36, wherein the two or more error severity levels include at least a correctable error severity level and an uncorrectable error severity level.

Example 38 includes the method of any of Examples 31 to 37, further comprising logging error-related transaction information for both the request transactions and the completion transactions for two or more respective communication protocols.

Example 39 includes the method of Example 38, wherein the two or more respective communication protocols include at least a Peripheral Component Interconnect Express (PCIe) protocol and a Compute Express Link (CXL) protocol.

Example 40 includes the method of any of Examples 31 to 39, further comprising logging the error-related transaction information in a set of memory-mapped registers.

Example 41 includes an apparatus, comprising means for processing request transactions and completion transactions for one or more respective communication protocols, and means for logging error-related transaction information for both the request transactions and the completion transactions for the one or more respective communication protocols.

Example 42 includes the apparatus of Example 41, wherein the error-related transaction information at least includes header log information associated with a completion transaction.

Example 43 includes the apparatus of any of Examples 41 to 42, wherein the error-related transaction information at least includes header log information associated with a correctable error.

Example 44 includes the apparatus of any of Examples 41 to 43, further comprising means for logging the error-related transaction information based on one or more respective values from one or more configuration registers.

Example 45 includes the apparatus of any of Examples 41 to 44, further comprising means for logging error-related transaction information in the memory associated with two or more error severity levels.

Example 46 includes the apparatus of Example 45, further comprising means for storing respective status information associated with two or more error severity levels.

Example 47 includes the apparatus of any of Examples 45 to 46, wherein the two or more error severity levels include at least a correctable error severity level and an uncorrectable error severity level.

Example 48 includes the apparatus of any of Examples 41 to 47, further comprising means for logging error-related transaction information for both the request transactions and the completion transactions for two or more respective communication protocols.

Example 49 includes the apparatus of Example 48, wherein the two or more respective communication protocols include at least a Peripheral Component Interconnect Express (PCIe) protocol and a Compute Express Link (CXL) protocol.

Example 50 includes the apparatus of any of Examples 41 to 49, further comprising means for logging the error-related transaction information in a set of memory-mapped registers.

Example 51 includes a method, comprising processing request transactions and completion transactions for one or more respective communication protocols, and logging error-related transaction information associated with two or more error severity levels for the one or more respective communication protocols.

Example 52 includes the method of Example 51, further comprising storing respective status information associated with two or more error severity levels.

Example 53 includes the method of any of Examples 51 to 52, wherein the two or more error severity levels include at least a correctable error severity level and an uncorrectable error severity level.

Example 54 includes the method of any of Examples 51 to 53, wherein the error-related transaction information at least includes header log information associated with a completion transaction.

Example 55 includes the method of any of Examples 51 to 54, wherein the error-related transaction information at least includes header log information associated with a correctable error.

Example 56 includes the method of any of Examples 51 to 55, further comprising logging the error-related transaction information based on one or more respective values from one or more configuration registers.

Example 57 includes the method of any of Examples 51 to 56, further comprising logging error-related transaction information for both the request transactions and the completion transactions for the one or more respective communication protocols.

Example 58 includes the method of Example 57, further comprising logging error-related transaction information for both the request transactions and the completion transactions for two or more respective communication protocols.

Example 59 includes the method of Example 58, wherein the two or more respective communication protocols include at least a Peripheral Component Interconnect Express (PCIe) protocol and a Compute Express Link (CXL) protocol.

Example 60 includes the method of any of Examples 51 to 59, further comprising logging error-related transaction information in a set of memory-mapped registers.

Example 61 includes an apparatus, comprising means for processing request transactions and completion transactions for one or more respective communication protocols, and means for logging error-related transaction information associated with two or more error severity levels for the one or more respective communication protocols.

Example 62 includes the apparatus of Example 61, further comprising means for storing respective status information associated with two or more error severity levels.

Example 63 includes the apparatus of any of Examples 61 to 62, wherein the two or more error severity levels include at least a correctable error severity level and an uncorrectable error severity level.

Example 64 includes the apparatus of any of Examples 61 to 63, wherein the error-related transaction information at least includes header log information associated with a completion transaction.

Example 65 includes the apparatus of any of Examples 61 to 64, wherein the error-related transaction information at least includes header log information associated with a correctable error.

Example 66 includes the apparatus of any of Examples 61 to 65, further comprising means for logging the error-related transaction information based on one or more respective values from one or more configuration registers.

Example 67 includes the apparatus of any of Examples 61 to 66, further comprising means for logging error-related transaction information for both the request transactions and the completion transactions for the one or more respective communication protocols.

Example 68 includes the apparatus of Example 67, further comprising means for logging error-related transaction information for both the request transactions and the completion transactions for two or more respective communication protocols.

Example 69 includes the apparatus of Example 68, wherein the two or more respective communication protocols include at least a Peripheral Component Interconnect Express (PCIe) protocol and a Compute Express Link (CXL) protocol.

Example 70 includes the apparatus of any of Examples 61 to 69, further comprising means for logging error-related transaction information in a set of memory-mapped registers.

Example 71 includes at least one non-transitory one machine readable medium comprising a plurality of instructions that, in response to being executed on a computing device, cause the computing device to perform one or more aspects of Examples 61 to 70.

Example 72 includes at least one non-transitory one machine readable medium comprising a plurality of instructions that, in response to being executed on a computing device, cause the computing device to perform one or more aspects of Examples 31 to 40.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain examples also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain examples are not described with reference to any particular programming language. It will be appreciated that a variety of programming languages may be used to implement the teachings of such examples as described herein.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. An apparatus, comprising:
a processor to process request transactions and completion transactions for one or more respective communication protocols;
memory coupled to the processor to store error-related transaction information; and
circuitry coupled to the memory to save the error-related transaction information in the memory for both the request transactions and the completion transactions for the one or more respective communication protocols.

2. The apparatus of claim 1, wherein the error-related transaction information at least includes header log information associated with a completion transaction.

3. The apparatus of claim 1, wherein the error-related transaction information at least includes header log information associated with a correctable error.

4. The apparatus of claim 1, wherein the memory comprises one or more configuration registers, and wherein the circuitry is further to:
save the error-related transaction information in the memory based on one or more respective values from the one or more configuration registers.

5. The apparatus of claim 1, wherein the circuitry is further to:
save the error-related transaction information in the memory associated with two or more error severity levels.

6. The apparatus of claim 5, further comprising:
two or more registers to store respective status information associated with two or more error severity levels.

7. The apparatus of claim 5, wherein the two or more error severity levels include at least a correctable error severity level and an uncorrectable error severity level.

8. An apparatus, comprising:
a processor to process request transactions and completion transactions for one or more respective communication protocols;
memory coupled to the processor to store error-related transaction information; and
circuitry coupled to the memory to save the error-related transaction information in the memory associated with two or more error severity levels for the one or more respective communication protocols.

9. The apparatus of claim 8, further comprising:
two or more registers to store respective status information associated with two or more error severity levels.

10. The apparatus of claim 8, wherein the two or more error severity levels include at least a correctable error severity level and an uncorrectable error severity level.

11. The apparatus of claim 8, wherein the error-related transaction information at least includes header log information associated with a completion transaction.

12. The apparatus of claim 8, wherein the error-related transaction information at least includes header log information associated with a correctable error.

13. The apparatus of claim 8, wherein the memory comprises one or more configuration registers, and wherein the circuitry is further to:
save the error-related transaction information in the memory based on one or more respective values from the one or more configuration registers.

14. The apparatus of claim 8, wherein the circuitry is further to:
save the error-related transaction information in the memory for both the request transactions and the completion transactions for the one or more respective communication protocols.

15. An electronic device, comprising:
a processor;
interface circuitry coupled to the processor to support one or more communication protocols; and
error management circuitry to collect header log information from both request transactions and completion transactions for the one or more communication protocols.

16. The electronic device of claim 15, wherein the error management circuitry comprises one or more configuration registers, and wherein the error management circuitry is further to:
collect the header log information based on one or more respective values from the one or more configuration registers.

17. The electronic device of claim 15, wherein the error management circuitry is further to:
collect header log information associated with two or more error severity levels.

18. The electronic device of claim 15, wherein the error management circuitry is further to:
collect header log information for both the request transactions and the completion transactions for two or more respective communication protocols.

19. The electronic device of claim 18, wherein the two or more respective communication protocols include at least a Peripheral Component Interconnect Express (PCIe) protocol and a Compute Express Link (CXL) protocol.

20. The electronic device of claim 15, wherein the error management circuitry comprises a set of memory-mapped registers to store the collected header log information.
